(19) United States
(12) Patent Application Publication
(10) Pub. No.: US 2021/0279447 A1
(43) Pub. Date: Sep. 9, 2021

(54) SYSTEMS AND METHODS FOR ANTI-SPOOFING PROTECTION USING MULTI-FRAME FEATURE POINT ANALYSIS

(71) Applicant: CyberLink Corp., Shindian City (TW)

(72) Inventors: Fu-Kai CHUANG, Taipei City (TW); Sheng-Hung LIU, Taipei City (TW)

(21) Appl. No.: 17/190,536

(22) Filed: Mar. 3, 2021

Related U.S. Application Data
(60) Provisional application No. 62/984,485, filed on Mar. 3, 2020.

(51) Int. Cl. G06K 9/00

(52) U.S. Cl. CPC G06K 9/00288; G06K 9/00899; G06K 9/00744; G06K 9/00268

(57) ABSTRACT

A computing device captures a live video of a user. For a first frame of the live video, the computing device identifies a first facial region of the user, determines a first plurality of regions of interest within the first facial region, and identifies feature points for each of the first plurality of regions of interest. For a second frame, the computing device identifies a second facial region of the user, determines a second plurality of regions of interest within the second facial region, and identifies feature points for each of the second plurality of regions of interest. The computing device generates transformed coordinates of first background feature points. The computing device determines a difference value between coordinates of second background feature points and the transformed coordinates of the first background feature points. The computing device determines whether the user is spoofing the computing device based on the difference value.

### CROSS-REFERENCE TO RELATED APPLICATION

This application claims priority to, and the benefit of, U.S. Provisional Patent Application entitled, “Method of Anti-Spoofing with Feature Pairs,” having Ser. No. 62/984,485, filed on Mar. 3, 2020, which is incorporated by reference in its entirety.

### TECHNICAL FIELD

The present disclosure generally relates to security measures in devices and more particularly, to systems and methods for anti-spoofing using feature point analysis across multiple image frames.

### BACKGROUND

Given the extensive use of smartphones and other computing devices in daily activities, such devices typically contain sensitive data and allow users to access mobile payment applications and other services. As such, there is an ongoing need for incorporating improved security measures to prevent unauthorized access to such devices.

### SUMMARY

In accordance with one embodiment, a computing device captures a live video of a user. For a first frame of the live video, the computing device identifies a first facial region of the user, determines a first plurality of regions of interest within the first facial region, and identifies a plurality of feature points for each of the first plurality of regions of interest. For a second frame of the live video, the computing device identifies a second facial region of the user, determines a second plurality of regions of interest within the second facial region, and identifies a plurality of feature points for each of the second plurality of regions of interest, wherein locations of the feature points in the second plurality of regions of interest in the second frame coincide with locations of the feature points in the first plurality of regions of interest in the first frame. The computing device generates a perspective transform matrix based on locations of the feature points in the second plurality of regions of interest in the second frame and locations of the feature points in the first plurality of regions of interest in the first frame to generate transformed coordinates of a plurality of first background feature points. The computing device determines a difference value between coordinates of a plurality of second background feature points and the transformed coordinates of the plurality of first background feature points. The computing device determines whether the user is spoofing the computing device to unlock the computing device based on the difference value.

Another embodiment is a system that comprises a memory storing instructions and a processor coupled to the memory. The processor is configured by the instructions and captures a live video of a user. For a first frame of the live video, the processor is configured identify a first facial region of the user, determine a first plurality of regions of interest within the first facial region, and identify a plurality of feature points for each of the first plurality of regions of interest. For a second frame of the live video, the processor is configured to identify a second facial region of the user, determine a second plurality of regions of interest within the second facial region, and identify a plurality of feature points for each of the second plurality of regions of interest, wherein locations of the feature points in the second plurality of regions of interest in the second frame coincide with locations of the feature points in the first plurality of regions of interest in the first frame. The processor is configured to generate a perspective transform matrix based on locations of the feature points in the second plurality of regions of interest in the second frame and locations of the feature points in the first plurality of regions of interest in the first frame to generate transformed coordinates of a plurality of first background feature points. The processor is configured to determine a difference value between coordinates of a plurality of second background feature points and the transformed coordinates of the plurality of first background feature points. The processor is configured to determine whether the user is spoofing the system to unlock the system based on the difference value.

Another embodiment is a non-transitory computer-readable storage medium storing instructions to be implemented by a computing device having a processor, wherein the instructions, when executed by the processor, cause the computing device to capture a live video of a user. For a first frame of the live video, the processor is configured identify a first facial region of the user, determine a first plurality of regions of interest within the first facial region, and identify a plurality of feature points for each of the first plurality of regions of interest. For a second frame of the live video, the processor is configured to identify a second facial region of the user, determine a second plurality of regions of interest within the second facial region, and identify a plurality of feature points for each of the second plurality of regions of interest, wherein locations of the feature points in the second plurality of regions of interest in the second frame coincide with locations of the feature points in the first plurality of regions of interest in the first frame. The processor is configured to generate a perspective transform matrix based on locations of the feature points in the second plurality of regions of interest in the second frame and locations of the feature points in the first plurality of regions of interest in the first frame to generate transformed coordinates of a plurality of first background feature points. The processor is configured to determine a difference value between coordinates of a plurality of second background feature points and the transformed coordinates of the plurality of first background feature points. The processor is configured to determine whether the user is spoofing the computing device to unlock the computing device based on the difference value.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Various aspects of the disclosure can be better understood with reference to the following drawings. The components in the drawings are not necessarily to scale, with emphasis instead being placed upon clearly illustrating the principles of the present disclosure. Moreover, in the drawings, like reference numerals designate corresponding parts throughout the several views.

FIG. 1 is a block diagram of a computing device for implementing anti-spoofing protection using multi-frame feature point analysis according to various embodiments of the present disclosure.

FIG. 2 is a schematic diagram of the computing device of FIG. 1 in accordance with various embodiments of the present disclosure.

FIG. 3 is a top-level flowchart illustrating examples of functionality implemented as portions of the computing device of FIG. 1 for implementing anti-spoofing protection using multi-frame feature point analysis according to various embodiments of the present disclosure.

FIG. 4 illustrates a user attempting to gain access to the computing device of FIG. 1, where the computing device is embodied as a smartphone equipped with a front facing camera according to various embodiments of the present disclosure.

FIG. 5 illustrates the determination of regions of interests by the computing device in FIG. 1 according to various embodiments of the present disclosure.

FIG. 6 illustrates identification of a facial feature point in each region of interest by the computing device in FIG. 1 according to various embodiments of the present disclosure.

FIG. 7 illustrates the computing device in FIG. 1 determining background feature points outside the facial region according to various embodiments of the present disclosure.

### DETAILED DESCRIPTION

A description of a system for implementing anti-spoofing protection using multi-frame feature point analysis is described followed by a discussion of the operation of the components within the system. An improved anti-spoofing technique implemented in a computing device is disclosed for preventing unauthorized access of personal devices that allow users to unlock the devices using an image of the user's facial region. Some computing devices are vulnerable to spoofing attempts by unauthorized users using images or videos of the owners of the devices. The anti-spoofing technique disclosed herein provide an improvement over existing facial recognition technologies.

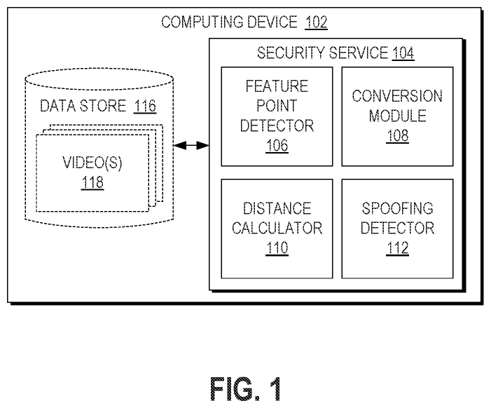

FIG. 1 is a block diagram of a computing device 102 in which the embodiments disclosed herein may be implemented. The computing device 102 may be embodied as a computing device such as, but not limited to, a smartphone, a tablet computing device, a laptop, and so on. A security service 104 executes on a processor of the computing device 102 and includes a feature point detector 106, a conversion module 108, a distance calculator 110, and a spoofing detector 112. As described in more detail below, the security service 104 detects attempts to spoof the computing device 102 using different metrics that involve both feature points within the facial region and feature points outside the facial region of the user attempting to gain access to the computing device 102.

The security service 104 detects attempts to spoof the computing device 102 using a distance metric involving feature points within the facial region. The feature point detector 106 is configured to obtain a live video 118 of the user using, for example, a front facing camera on the computing device 102 and store the video 118 in a data store 116. The video 118 stored in the data store 116 may be encoded in formats including, but not limited to, Motion Picture Experts Group (MPEG)-1, MPEG-2, MPEG-4, H.264, Third Generation Partnership Project (3GPP), 3GPP-2, Standard-Definition Video (SD-Video), High-Definition Video (HD-Video), Digital Versatile Disc (DVD) multimedia, Video Compact Disc (VCD) multimedia, High-Definition Digital Versatile Disc (HD-DVD) multimedia, Digital Television Video/High-definition Digital Television (DTV/HDTV) multimedia, Audio Video Interleave (AVI), Digital Video (DV), QuickTime (QT) file, Windows Media Video (WMV), Advanced System Format (ASF), Real Media (RM), Flash Media (FLV), an MPEG Audio Layer III (MP3), an MPEG Audio Layer II (MP2), Waveform Audio Format (WAV), Windows Media Audio (WMA), 360 degree video, 3D scan model, or any number of other digital formats.

For a first frame of the captured video 118, the feature point detector 106 identifies a first facial region of the user and determines a first plurality of regions of interest within the first facial region. This may be achieved using a scale-invariant feature transform (SIFT) algorithm, a speeded up robust features (SURF) algorithm, or other feature points detection algorithm. The feature point detector 106 is further configured to identify a plurality of feature points for each of the first plurality of regions of interest.

For a second frame of the capture video 118, the feature point detector 106 similarly identifies a second facial region of the user and determines a second plurality of regions of interest within the second facial region. The feature point detector 106 is further configured to identify a plurality of feature points for each of the second plurality of regions of interest, and determine where the locations of the feature points in the second plurality of regions of interest in the second frame coincide with the locations of the feature points in the first plurality of regions of interest in the first frame. The one or more feature points may similarly be identified using a scale-invariant feature transform (SIFT) algorithm, a speeded up robust features (SURF) algorithm, or other feature points detection algorithms. For some embodiments, the feature point detector 106 identifies a second facial region of the user and determines a second plurality of regions of interest within the second facial region based on the first plurality of regions of interest within the first facial region where the first plurality of regions correspond to the second plurality of regions.

The conversion module 108 is configured to generate a perspective transform matrix based on the locations of the feature points in the second plurality of regions of interest in the second frame and the locations of the feature points in the first plurality of regions of interest in the first frame to generate transformed coordinates of a plurality of first background feature points.

The distance calculator 110 determines a difference value between the coordinates of a plurality of second background feature points and the transformed coordinates of the plurality of first background feature points. Based on the value of this difference value, the spoofing detector 112 determines whether the user is spoofing the computing device 102 in an attempt to unlock the computing device 102. For some embodiments, the spoofing detector 112 determines that the user is spoofing the computing device 102 when the difference value is less than a threshold value.

For some embodiments, the security service 104 may also detect attempts to spoof the computing device 102 using a distance metric involving feature points located outside the facial region. For the first frame of the live video, the feature point detector 106 determines a plurality of first background feature points outside the facial region. Similarly, for the second frame of the live video, the feature point detector 106 determines a plurality of second background feature points outside the facial region where the locations of the first background feature points coincide with locations of the second background feature points. The feature point detector 106 then generates the transformed coordinates of the plurality of first background points based on the perspective transform matrix and the plurality of first background feature points.

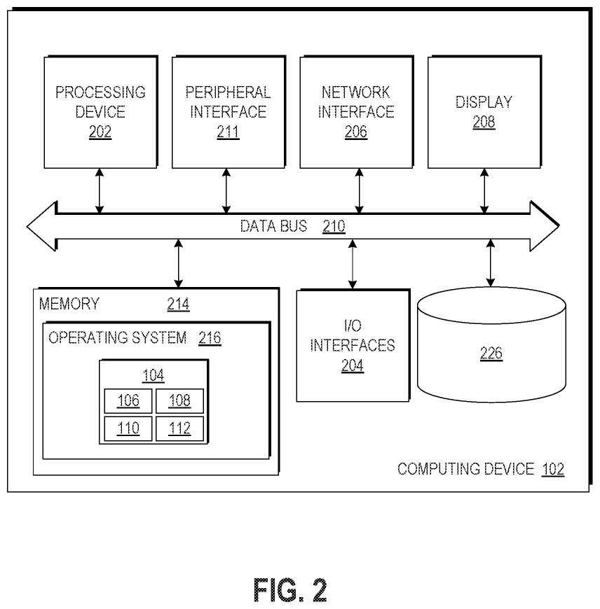

FIG. 2 illustrates a schematic block diagram of the computing device 102 in FIG. 1. The computing device 102 may be embodied as a desktop computer, portable computer, dedicated server computer, multiprocessor computing device, smart phone, tablet, and so forth. As shown in FIG. 2, the computing device 102 comprises memory 214, a processing device 202, a number of input/output interfaces 204, a network interface 206, a display 208, a peripheral interface 211, and mass storage 226, wherein each of these components are connected across a local data bus 210.

The processing device 202 may include a custom made processor, a central processing unit (CPU), or an auxiliary processor among several processors associated with the computing device 102, a semiconductor based microprocessor (in the form of a microchip), a macroprocessor, one or more application specific integrated circuits (ASICs), a plurality of suitably configured digital logic gates, and so forth.

The memory 214 may include one or a combination of volatile memory elements (e.g., random-access memory (RAM, such as DRAM, and SRAM, etc.)) and nonvolatile memory elements (e.g., ROM, hard drive, tape, CDROM, etc.). The memory 214 typically comprises a native operating system 216, one or more native applications, emulation systems, or emulated applications for any of a variety of operating systems and/or emulated hardware platforms, emulated operating systems, etc. For example, the applications may include application specific software which may comprise some or all the components of the computing device 102 displayed in FIG. 1.

In accordance with such embodiments, the components are stored in memory 214 and executed by the processing device 202, thereby causing the processing device 202 to perform the operations/functions disclosed herein. For some embodiments, the components in the computing device 102 may be implemented by hardware and/or software.

Input/output interfaces 204 provide interfaces for the input and output of data. For example, where the computing device 102 comprises a personal computer, these components may interface with one or more user input/output interfaces 204, which may comprise a keyboard or a mouse, as shown in FIG. 2. The display 208 may comprise a computer monitor, a plasma screen for a PC, a liquid crystal display (LCD) on a hand held device, a touchscreen, or other display device.

In the context of this disclosure, a non-transitory computer-readable medium stores programs for use by or in connection with an instruction execution system, apparatus, or device. More specific examples of a computer-readable medium may include by way of example and without limitation: a portable computer diskette, a random access memory (RAM), a read-only memory (ROM), an erasable programmable read-only memory (EPROM, EEPROM, or Flash memory), and a portable compact disc read-only memory (CDROM) (optical).

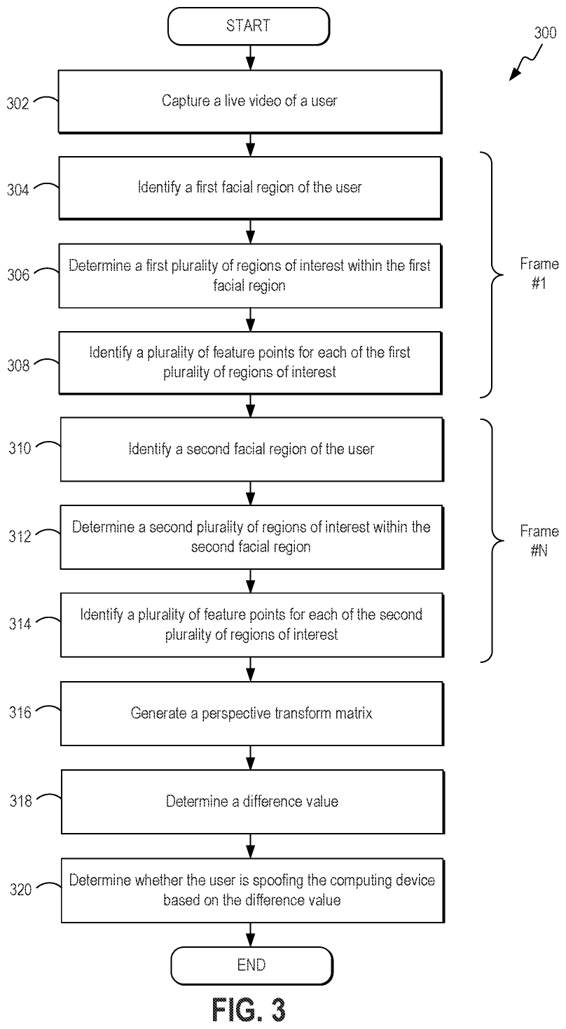

Reference is made to FIG. 3, which is a flowchart 300 in accordance with various embodiments for implementing anti-spoofing protection using multi-frame feature point analysis performed by the computing device 102 of FIG. 1. It is understood that the flowchart 300 of FIG. 3 provides merely an example of the different types of functional arrangements that may be employed to implement the operation of the various components of the computing device 102. As an alternative, the flowchart 300 of FIG. 3 may be viewed as depicting an example of steps of a method implemented in the computing device 102 according to one or more embodiments.

Although the flowchart 300 of FIG. 3 shows a specific order of execution, it is understood that the order of execution may differ from that which is displayed. For example, the order of execution of two or more blocks may be scrambled relative to the order shown. Also, two or more blocks shown in succession in FIG. 3 may be executed concurrently or with partial concurrence. It is understood that all such variations are within the scope of the present disclosure.

At block 302, the computing device 102 captures a live video of a user. For a first frame of the live video, the computing device 102 identifies a first facial region of the user (block 304), determines a first plurality of regions of interest within the first facial region (block 306), and identifies a plurality of feature points for each of the first plurality of regions of interest (block 308). During the first frame, the computing device 102 may also determine a plurality of first background feature points outside the first facial region.

For a second frame of the live video, the computing device 102 identifies a second facial region of the user (block 310), determines a second plurality of regions of interest within the second facial region (block 312), and identifies a plurality of feature points for each of the second plurality of regions of interest (block 314). The first facial region of the user corresponds to the second facial region of the user. The locations of the feature points in the second plurality of regions of interest in the second frame coincide with locations of the feature points in the first plurality of regions of interest in the first frame. The computing device 102 detects the feature points in the first plurality of regions of interest and the feature points in the second plurality of regions of interest within the first facial region using a scale-invariant feature transform (SIFT) algorithm, a speeded up robust features (SURF) algorithm, or other feature points detection algorithm. During the second frame, the computing device 102 may also determine a plurality of second background feature points outside the second facial region, where the locations of the first background feature points coincide with the locations of the second background feature points.

At block 316, the computing device 102 generates a perspective transform matrix based on locations of the feature points in the second plurality of regions of interest in the second frame and locations of the feature points in the first plurality of regions of interest in the first frame to generate transformed coordinates of a plurality of first background feature points. For some embodiments, the computing device 102 generates the transformed coordinates of the plurality of first background points based on the perspective transform matrix and the plurality of first background feature points.

At block 318, the computing device 102 determines a difference value between coordinates of a plurality of second background feature points and the transformed coordinates of the plurality of first background feature points. At block 320, the computing device 102 determines whether the user is spoofing the computing device 102 based on the difference value. For some embodiments, the computing device 102 determines that the user is spoofing the computing device 102 when the difference value is less than a threshold value. Thereafter, the process in FIG. 3 ends.

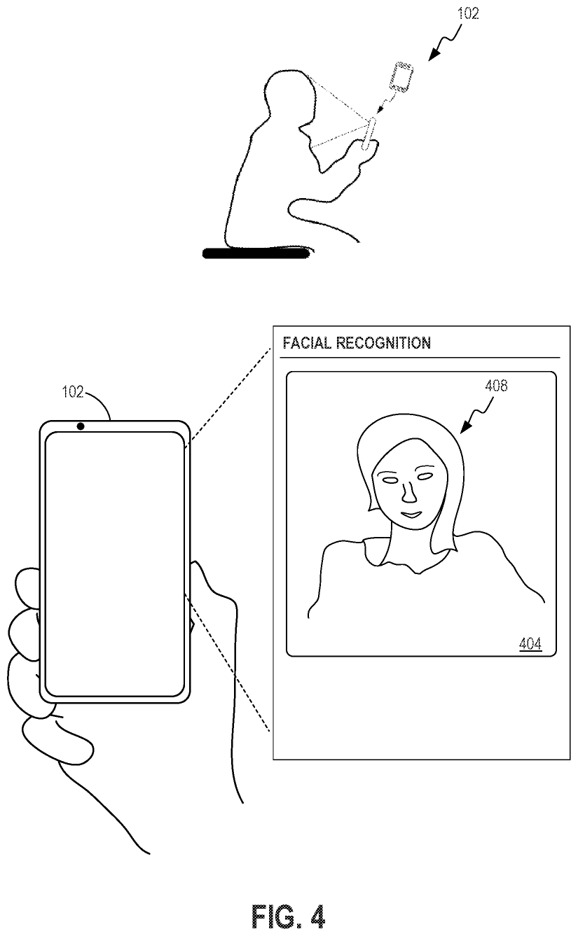

To further illustrate various aspects of the present invention, reference is made to the following figures. FIG. 4 illustrates a user attempting to gain access to a computing device 102 embodied as a smartphone equipped with a front facing camera. The front facing camera of the computing device 102 captures a live video of the user's facial region 408 for purposes of verifying the identity of the user attempting to gain access to the computing device 102. For some embodiments, the live video is displayed in a viewing window 404, and the computing device 102 compares the facial region 408 depicted in the live video to a reference facial region stored in the data store 116 (FIG. 1). If a match is identified, the user is granted access to the computing device 102. For some embodiments, the computing device 102 determines whether the user is spoofing the system based on the difference value.

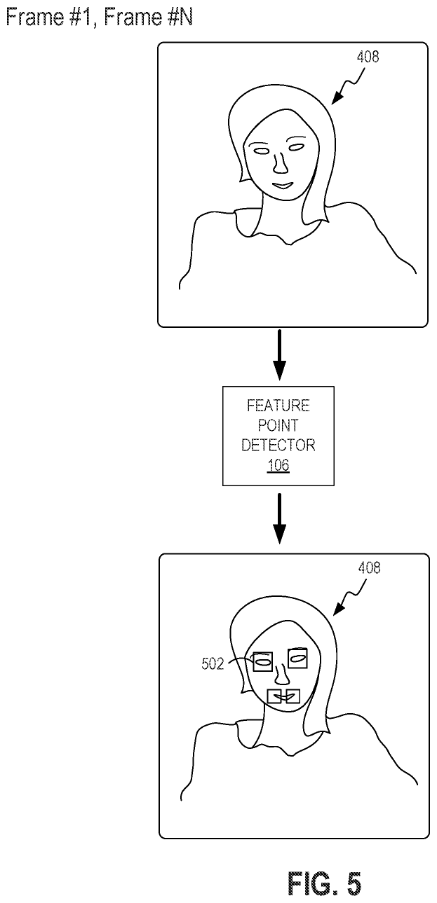

FIG. 5 illustrates the determination of regions of interests by the computing device 102 in FIG. 1. For some embodiments, the feature point detector 106 executing in the computing device 102 determines regions of interest 502 in a facial region 408 of the user. For some embodiments, the feature point detector 106 identifies a second facial region of the user and determines a second plurality of regions of interest within the second facial region based on the first plurality of regions of interest within the first facial region where the first plurality of regions correspond to the second plurality of regions.

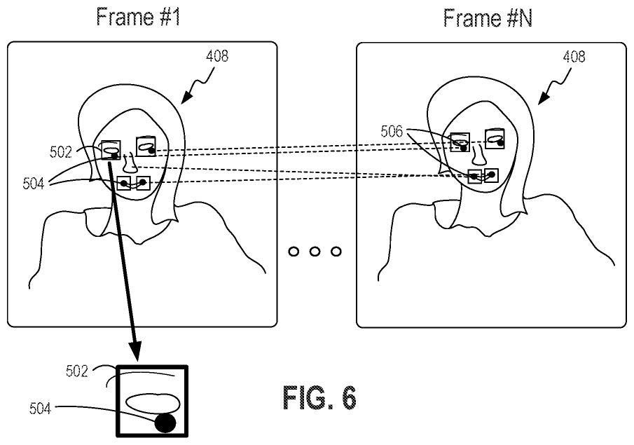

As shown in FIG. 6, the feature point detector 106 is further configured to identify a plurality of feature points 504 for each of the regions of interest 502. Once the feature point detector 106 identifies a plurality of feature points 504 within each region of interest 502 for a first frame, the feature point detector 106 identifies corresponding feature points 506 for each region of interest 502 in the second frame.

The computing device 102 generates a perspective transform matrix M based on the locations of the feature points (Pin2) in the second plurality of regions of interest in the second frame and locations of the feature points (Pin1) in the first plurality of regions of interest in the first frame. At least four feature points are utilized for determining the perspective transform matrix M.

The computing device 102 then determines a plurality of second background feature points (Pout2) outside the facial region, where the locations of the first background feature points (Pout1) coincide with locations of the second background feature points (Pout2). The computing device 102 performs the perspective transform M on the plurality of first background feature points (Pout1) to generate transformed coordinates of the plurality of first background point Pout1′ where the perspective transform M is generated based on locations of the feature points (Pin1) in the first plurality of regions of interest in the first frame and locations of the feature points (Pin2) in the second plurality of regions of interest in the second frame. The computing device 102 calculates a difference value D(diff) between transformed coordinates of the plurality of first background point Pout1′ and coordinates of the second background points in the second frame (Pout2).

For some embodiments, the spoofing detector 112 (FIG. 1) detects an attempt to spoof the computing device 102 based on a summation of the difference value D(diff) spanning multiple iterations involving frame pairs. In particular, a spoofing attempt is detected if Σ[D(diff)]<threshold value. The spoofing detector 112 may also detect an attempt to spoof the computing device 102 based on the total instances (represented by C(diff)) in which the difference value D(diff) spanning multiple iterations involving frame pairs is greater than the threshold value. If the count value C(diff) is less than a threshold count value, the spoofing detector 112 determines that an attempt has been made to spoof the computing device 102.

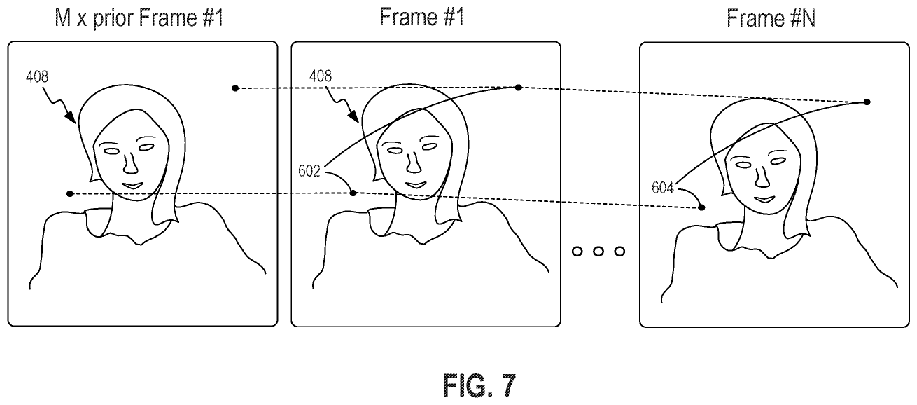

FIG. 7 illustrates the computing device 102 in FIG. 1 determining a plurality of background feature points 602 outside the facial region 408. Based on the location of the facial region 408 determined by the feature point detector 106, the feature point detector 106 identifies background feature points 602 found in the background of the video that fall outside the facial region 408. Calculations similar to those discussed involving feature points discussed above are applied to the background feature points 602 to determine whether the user is attempting to spoof the computing device 102.

The original coordinates of the background feature points 602 in the first frame (Frame #1) is represented by (Pout1). A transformed coordinate of (Pout1) is represented by Pout1″ where the transformed coordinate is calculated by M×Pout1=Pout1″, where M represents a perspective transform matrix. The computing device 102 determines a difference value represented by D(diff) by calculating a difference between coordinates of the second background feature points 604 in the second frame (Frame #N) and the transformed coordinates of the first background feature points. Note that the first frame and the second frame may comprise adjacent frames or non-adjacent frames.

The spoofing detector 112 (FIG. 1) detects an attempt to spoof the computing device 102 based on a summation of the difference value D(diff) spanning multiple iterations involving frame pairs. In particular, a spoofing attempt is detected if Σ[D(diff)]<threshold value. As an alternative, the spoofing detector 112 detects an attempt to spoof the computing device 102 based on the total instances (represented by C(diff)) in which the difference value D(diff) spanning multiple iterations involving frame pairs is greater than the threshold value. If the count value C(diff) is less than a threshold count value, the spoofing detector 112 determines that an attempt has been made to spoof the computing device 102 based on the difference value. In this regard, the computing device 102 detects attempts to spoof the computing device 102 using different metrics that involve both feature points within the facial region and feature points outside the facial region (i.e., background feature points).

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A method implemented in a computing device, comprising:
capturing a live video of a user;
for a first frame of the live video:
identifying a first facial region of the user;
determining a first plurality of regions of interest within the first facial region; and
identifying a plurality of feature points for each of the first plurality of regions of interest;
for a second frame of the live video:
identifying a second facial region of the user;
determining a second plurality of regions of interest within the second facial region; and
identifying a plurality of feature points for each of the second plurality of regions of interest, wherein locations of the feature points in the second plurality of regions of interest in the second frame coincide with locations of the feature points in the first plurality of regions of interest in the first frame;
generating a perspective transform matrix based on locations of the feature points in the second plurality of regions of interest in the second frame and locations of the feature points in the first plurality of regions of interest in the first frame to generate transformed coordinates of a plurality of first background feature points;
determining a difference value between coordinates of a plurality of second background feature points and the transformed coordinates of the plurality of first background feature points; and
determining whether the user is spoofing the computing device based on the difference value.

2. The method of claim 1, wherein a determination is made that the user is spoofing the computing device when the difference value is less than a threshold value.

3. The method of claim 1, wherein the feature points in the first plurality of regions of interest and the feature points in the second plurality of regions of interest within the first facial region are detected using a scale-invariant feature transform (SIFT) algorithm or a speeded up robust features (SURF) algorithm.

4. The method of claim 1, further comprising:
for the first frame of the live video:
determining a plurality of first background feature points outside the first facial region;
for the second frame of the live video:
determining a plurality of second background feature points outside the second facial region, wherein locations of the first background feature points coincide with locations of the second background feature points; and
generating the transformed coordinates of the plurality of first background points based on the perspective transform matrix and the plurality of first background feature points.

5. A system, comprising:
a memory storing instructions;
a processor coupled to the memory and configured by the instructions to at least:
capture a live video of a user;
for a first frame of the live video:
identify a first facial region of the user;
determine a first plurality of regions of interest within the first facial region; and
identify a plurality of feature points for each of the first plurality of regions of interest;
for a second frame of the live video:
identify a second facial region of the user;
determine a second plurality of regions of interest within the second facial region; and
identify a plurality of feature points for each of the second plurality of regions of interest, wherein locations of the feature points in the second plurality of regions of interest in the second frame coincide with locations of the feature points in the first plurality of regions of interest in the first frame;
generate a perspective transform matrix based on locations of the feature points in the second plurality of regions of interest in the second frame and locations of the feature points in the first plurality of regions of interest in the first frame to generate transformed coordinates of a plurality of first background feature points;
determine a difference value between coordinates of a plurality of second background feature points and the transformed coordinates of the plurality of first background feature points; and
determine whether the user is spoofing the system based on the difference value.

6. The system of claim 5, wherein the processor determines that that the user is spoofing the system when the difference value is less than a threshold value.

7. The system of claim 5, wherein the feature points in the first plurality of regions of interest and the feature points in the second plurality of regions of interest within the first facial region are detected by the processor using a scale-invariant feature transform (SIFT) algorithm or a speeded up robust features (SURF) algorithm.

8. The system of claim 5, wherein the processor is further configured to:
for the first frame of the live video:
determine a plurality of first background feature points outside the first facial region;
for the second frame of the live video:
determine a plurality of second background feature points outside the second facial region, wherein locations of the first background feature points coincide with locations of the second background feature points; and
generate the transformed coordinates of the plurality of first background points based on the perspective transform matrix and the plurality of first background feature points.

9. A non-transitory computer-readable storage medium storing instructions to be implemented by a computing device having a processor, wherein the instructions, when executed by the processor, cause the computing device to at least:
capture a live video of a user;
for a first frame of the live video:
identify a first facial region of the user;
determine a first plurality of regions of interest within the first facial region; and
identify a plurality of feature points for each of the first plurality of regions of interest;
for a second frame of the live video:
identify a second facial region of the user;
determine a second plurality of regions of interest within the second facial region; and
identify a plurality of feature points for each of the second plurality of regions of interest, wherein locations of the feature points in the second plurality of regions of interest in the second frame coincide with locations of the feature points in the first plurality of regions of interest in the first frame;
generate a perspective transform matrix based on locations of the feature points in the second plurality of regions of interest in the second frame and locations of the feature points in the first plurality of regions of interest in the first frame to generate transformed coordinates of a plurality of first background feature points;
determine a difference value between coordinates of a plurality of second background feature points and the transformed coordinates of the plurality of first background feature points; and
determine whether the user is spoofing the computing device based on the difference value.

10. The non-transitory computer-readable storage medium of claim 9, wherein the processor determines that that the user is spoofing the computing device when the difference value is less than a threshold value.

11. The non-transitory computer-readable storage medium of claim 9, wherein the feature points in the first plurality of regions of interest and the features points in the second plurality of regions of interest within the first facial region are detected by the processor using a scale-invariant feature transform (SIFT) algorithm ora speeded up robust features (SURF) algorithm.

12. The non-transitory computer-readable storage medium of claim 9, wherein the processor is further configured to:
for the first frame of the live video:
determine a plurality of first background feature points outside the first facial region;
for the second frame of the live video:
determine a plurality of second background feature points outside the second facial region, wherein locations of the first background feature points coincide with locations of the second background feature points; and
generate the transformed coordinates of the plurality of first background points based on the perspective transform matrix and the plurality of first background feature points.
